(19) United States
(12) Patent Application Publication
(10) Pub. No.: US 2026/0106097 A1
(43) Pub. Date: Apr. 16, 2026

(54) INTERRUPTING DEVICE

(71) Applicant: Panasonic Intellectual Property Management Co., Ltd., Osaka (JP)

(72) Inventors: SHUN ITO, Hyogo (JP); MASATO NAKAMURA, Hyogo (JP); ABEL MATA ZETINA, Osaka (JP); SHINYA KIMOTO, Osaka (JP); KATSUYA URUMA, Osaka (JP)

(21) Appl. No.: 19/127,729

(22) PCT Filed: Aug. 23, 2023
(86) PCT No.: PCT/JP2023/030348

§ 371 Date: May 6, 2025

(30) Foreign Application Priority Data
Nov. 24, 2022 (JP) 2022-187178

(51) Int. Cl. H01H 39/00

(52) U.S. Cl. CPC H01H 39/00

(57) ABSTRACT

This breaker device includes: a casing including a projecting portion; an igniter that generates gas; a pusher located below the igniter; and a conductor including a separating portion located inside the casing and below the pusher, the separating portion being to be cut off by the pusher under pressure of the gas generated by the igniter. The projecting portion of the casing is located below the separating portion and protrudes upward, and the projecting portion of the casing deforms downward by being pressed by the pusher.

### TECHNICAL FIELD

The present disclosure relates to breaker devices.

### BACKGROUND ART

There are conventionally known breaker devices that, when in use, are connected to an electrical circuit. Among the breaker devices, a breaker device has been disclosed that includes: a gas generator (igniter); a conducting member (conductor) that forms a part of an electrical circuit; and a blade (pusher), and is configured to cut the conducting member by moving the blade toward the conducting member at high speed with gas generated by the gas generator (refer to Patent Literature (PTL) 1).

### CITATION LIST

### Patent Literature

PTL 1: Unexamined Japanese Patent Publication No. 2012-138247

### SUMMARY OF INVENTION

### Technical Problem

There may be another device positioned around the breaker device, and it may be desirable that when the pusher cuts the conductor, the outer shape of a casing that houses the conductor, the pusher, and the like do not deform.

The present disclosure provides a breaker device capable of minimizing the deformation of the outer shape of a casing when a pusher cuts a conductor.

A breaker device according to one aspect of the present disclosure includes: a casing including a first projecting portion; an igniter that generates gas; a pusher located below the igniter; and a conductor including a separating portion located inside the casing and below the pusher, the separating portion being to be cut off by the pusher under pressure of the gas generated by the igniter, and is configured so that the first projecting portion of the casing is located below the separating portion and protrudes upward, and the first projecting portion of the casing deforms downward by being pressed by the pusher.

According to one aspect of the present disclosure, it is possible to minimize the deformation of the outer shape of the casing when the pusher cuts the conductor.

### BRIEF DESCRIPTION OF DRAWINGS

FIG. 1A is a front view illustrating a breaker device according to Embodiment 1.

FIG. 1B is a perspective view illustrating a breaker device according to Embodiment 1.

FIG. 2 is a cross-sectional view illustrating a breaker device according to Embodiment 1.

FIG. 3 is a diagram for describing an interrupting operation of a breaker device according to Embodiment 1.

FIG. 4 is a flowchart illustrating a manufacturing process of a breaker device according to Embodiment 1.

FIG. 5 is a perspective view illustrating a breaker device according to Embodiment 2.

FIG. 6 is a cross-sectional view illustrating a breaker device according to Embodiment 2.

FIG. 7 is a cross-sectional view illustrating the first example of various variations of a lower casing according to each exemplary embodiment.

FIG. 8 is a cross-sectional view illustrating the second example of various variations of a lower casing according to each exemplary embodiment.

FIG. 9 is a cross-sectional view illustrating the third example of various variations of a lower casing according to each exemplary embodiment.

FIG. 10 is a cross-sectional view illustrating the first example of a variation of a breaker device according to each exemplary embodiment.

FIG. 11 is a cross-sectional view illustrating the second example of a variation of a breaker device according to each exemplary embodiment.

FIG. 12 is a cross-sectional view illustrating the third example of a variation of a breaker device according to each exemplary embodiment.

FIG. 13 is a cross-sectional view illustrating the fourth example of a variation of a breaker device according to each exemplary embodiment.

FIG. 14 is a diagram for describing an interrupting operation of a breaker device according to the fourth example of a variation.

### DESCRIPTION OF EMBODIMENTS

A breaker device according to one aspect of the present disclosure includes: a casing including a first projecting portion; an igniter that generates gas; a pusher located below the igniter; and a conductor including a separating portion located inside the casing and below the pusher, the separating portion being to be cut off by the pusher under pressure of the gas generated by the igniter. The first projecting portion of the casing is located below the separating portion and protrudes upward. The first projecting portion of the casing deforms downward by being pressed by the pusher.

Thus, the first projecting portion deforms downward when pressed by the pusher moving downward due to the pressure of the gas generated by the igniter. This means that by deforming downward, the first projecting portion can absorb the stress from the pusher and thus can keep the casing from bulging due to the stress from the pusher. As a result, with the breaker device according to one aspect of the present disclosure, when the pusher cuts the conductor, the first projecting portion absorbs the stress from the pusher, and thus it is possible to minimize the deformation of the outer shape of the casing.

Furthermore, for example, it is preferable that the first projecting portion of the casing be tapered upward.

Thus, a part of the first projecting portion that is at a right angle can be reduced and therefore, local stress concentration can be reduced.

Furthermore, for example, it is preferable that a distance between a leading end portion of the first projecting portion of the casing and the separating portion be less than a vertical length of the pusher before the separating portion is cut off from the conductor.

As a result, when the pusher cuts the conductor, the insulation distance between cut surfaces of the conductor can be increased. Thus, it is possible to reduce the occurrence of an electric arc when the conductor is cut.

Furthermore, for example, it is preferable that the casing include a first holder, the first holder include: a first bottom portion; and the first projecting portion protruding upward from the first bottom portion, and when the pusher presses the first projecting portion, the first bottom portion of the first holder deform.

Thus, the bottom portion connected to the first projecting portion deforms in conjunction with the deformation of the first projecting portion and therefore, stress concentration on the first projecting portion can be reduced. As a result, the casing can be protected from damage.

Furthermore, for example, it is preferable that the first projecting portion include a first wall portion extending upward from the first bottom portion, and the first wall portion be cylindrical.

Thus, since the first projecting portion includes the cylindrical first wall portion configured to be easily crushable, the stress from the pusher can be effectively absorbed. As a result, it is possible to further minimize the deformation of the outer shape of the casing.

Furthermore, for example, it is preferable that the first projecting portion include a first wall portion extending upward from the first bottom portion, the first holder include a recessed portion as viewed from below, and the first wall portion of the first projecting portion form an inner surface of the recessed portion.

Thus, a part of the casing shares the role of the first projecting portion and therefore, it is possible to minimize the deformation of the outer shape of the casing without adding another member.

Furthermore, for example, it is preferable that the first holder further include a side wall portion, the side wall portion and the first projecting portion be connected via the first bottom portion, and when the pusher presses the first projecting portion of the casing, the side wall portion of the first holder deform.

Thus, the side wall portion connected to the first projecting portion via the first bottom portion also deforms in conjunction with the deformation of the first projecting portion and therefore, stress concentration on the first projecting portion can be further reduced. As a result, the casing can be further protected from damage.

Furthermore, for example, it is preferable that the first holder further include a side wall portion, the side wall portion and the first projecting portion be connected via the first bottom portion, and at least a part of an outer surface of the first bottom portion be inclined upward from the first projecting portion toward the side wall portion.

Thus, since the first bottom portion includes a portion inclined upward, it is possible to minimize the deformation of the outer shape of the casing.

Furthermore, for example, it is preferable that the first holder further include a side wall portion, the side wall portion and the first projecting portion are connected via the first bottom portion, and at least a part of an inner surface of the first bottom portion be inclined upward from the first projecting portion toward the side wall portion.

Thus, pressure applied to the inside of the casing can be dispersed and therefore, it is possible to minimize the deformation of the outer shape of the casing.

Furthermore, for example, it is preferable that the first holder further include a side wall portion, the side wall portion and the first projecting portion are connected via the first bottom portion, and the first bottom portion include: a connecting portion connected to the first projecting portion; and an inclined portion that connects the connecting portion and the side wall portion and includes an outer surface and an inner surface each inclined upward from the connecting portion toward the side wall portion.

Thus, pressure applied to the inside of the casing can be dispersed and therefore, it is possible to minimize the deformation of the outer shape of the casing.

Furthermore, for example, it is preferable that the casing further include a second holder, the second holder be located below the first holder, and the first holder and the first projecting portion be integrally formed.

Thus, the first holder can absorb at least part of the stress from the pusher and therefore, it is possible to minimize the deformation of the second holder constituting the outer full of the breaker device. As a result, it is possible to minimize the deformation of the outer shape of the casing.

Furthermore, for example, it is preferable that the second holder include a second projecting portion protruding upward, and the second projecting portion be located below the first projecting portion of the first holder.

Thus, the second projecting portion can deform to absorb stress that the first projecting portion has failed to absorb and therefore can keep the second holder from bulging. This means that it is possible to minimize the deformation of the outer shape of the casing.

Furthermore, for example, it is preferable that the second holder include: a second bottom portion; and the second projecting portion protruding upward from the second bottom portion, the second projecting portion include a second wall portion extending upward from the second bottom portion, and the second wall portion be located along the first wall portion.

Thus, the first projecting portion and the second projecting portion are disposed on top of each other and therefore, the double-layered projecting portions can effectively absorb the stress from the pusher. As a result, it is possible to effectively minimize the deformation of the outer shape of the casing.

Furthermore, for example, it is preferable that the conductor further include a holding portion adjacent to the separating portion, and after the pusher cuts off the separating portion, an upper end of the pusher be located at a level above a cut surface of the holding portion between the holding portion and the separating portion.

Thus, the pusher is located at a level above the holding portion, meaning that the arc path is long; therefore, the electric arc can be effectively blocked.

Furthermore, for example, it is preferable that when the pusher presses the first projecting portion downward and stops, a distance between a lower end of the pusher and a lower end of the cut surface of the holding portion be greater than or equal to a distance between the upper end of the pusher and an upper end of the cut surface of the holding portion.

Thus, the pusher does not move past the cut surface of the conductor and therefore, the arc path can be lengthened and the electric arc occurring after the stop of the pusher can be effectively blocked.

Furthermore, for example, it is preferable that the breaker device further include a resin member covering the conductor, the resin member include: an embedding portion in which the conductor is embedded; a first cylindrical portion in which the pusher is disposed; and a second cylindrical portion located at a level below the first cylindrical portion, an inner diameter of the first cylindrical portion be less than an inner diameter of the second cylindrical portion, and when the pusher presses the first projecting portion downward and stops, an upper end of the pusher be adjacent to the first cylindrical portion and a lower end of the pusher be adjacent to the second cylindrical portion.

Thus, after the pusher stops, the lower end of the pusher can be positioned in the space formed by the second cylindrical portion having a large capacity. This means that after the pusher stops, the separating portion cut off by the pusher can be positioned in said space. Since said space has a large capacity such that inner pressure resulting from an electric arc can be reduced, the breaker device can reduce pressure that is applied to the casing.

Furthermore, for example, it is preferable that the breaker device further include: a casing; an igniter that generates gas; a conductor including a separating portion located inside the casing; a pusher that is located below the igniter and cuts off the separating portion from the conductor by receiving pressure of the gas generated by the igniter; and a hollow member that is located inside the casing, is located below the separating portion, and is hollow inside, the separating portion be located below the pusher, and when the pusher presses the hollow member, the hollow member deform downward.

Thus, the hollow member, which is a separate member, can absorb the stress from the pusher and therefore, it is possible to minimize the deformation of the outer shape of the casing.

Hereinafter, exemplary embodiments will be specifically described with reference to the drawings.

Note that each of the exemplary embodiments described below shows a general or specific example. The numerical values, shapes, structural elements, the arrangement and connection of the structural elements, steps (manufacturing steps), the processing order of the steps (manufacturing steps), etc., shown in the following exemplary embodiments are mere examples, and are not intended to limit the present disclosure. Among the structural elements in the following exemplary embodiments, structural elements not recited in any one of the independent claims are described as optional structural elements.

Note that the figures are schematic diagrams and are not necessarily precise illustrations. Therefore, for example, scale reduction and the like in the figures are not necessarily the same. Furthermore, in the figures, substantially identical elements are assigned the same reference signs, and overlapping description will be omitted or simplified.

In the present specification and the drawings, the X-axis, the Y-axis, and the Z-axis represent three axes of the right-handed three-dimensional Cartesian coordinate system. In each of the exemplary embodiments, the Z-axis direction is a direction of movement of the pusher. In the present specification, the phrase “in plan view” indicates viewing the breaker device in the Z-axis direction, and the term “lateral/side” indicates a direction perpendicular to the Z-axis direction. Furthermore, in the present specification, the Z-axis direction is also referred to as the up-down or vertical direction. Note that the up-down direction of the breaker device in the present specification merely indicates relative positioning of elements included in the breaker device for the sake of description of each of the exemplary embodiments. For example, in the present specification, the terms “up/upward/above/top” and “down/downward/below/bottom” do not indicate an upward direction (vertically upward) and a downward direction (vertically downward) in a sense of absolute space, but are used as terms defined by relative positioning on the basis of the direction of movement of the pusher. The posture of the breaker device when installed is not limited by the directions illustrated in the drawings.

Furthermore, in the present specification, terms indicating the relationship between elements such as being equal and being parallel, terms indicating the shapes of elements such as a trapezoid and a circular column, numerical values, and numerical ranges are not expressions referring to only exact meanings, but are expressions referring to substantially equivalent ranges including, for example, approximately a few percent (for example, approximately 10%) differences.

Furthermore, in the present specification, ordinal numbers such as “first” and “second” do not indicate the number of structural elements or the sequence of structural elements, but are used for the purpose of avoiding confusion and distinguishing between structural elements of the same kind, unless otherwise noted.

### Embodiment 1

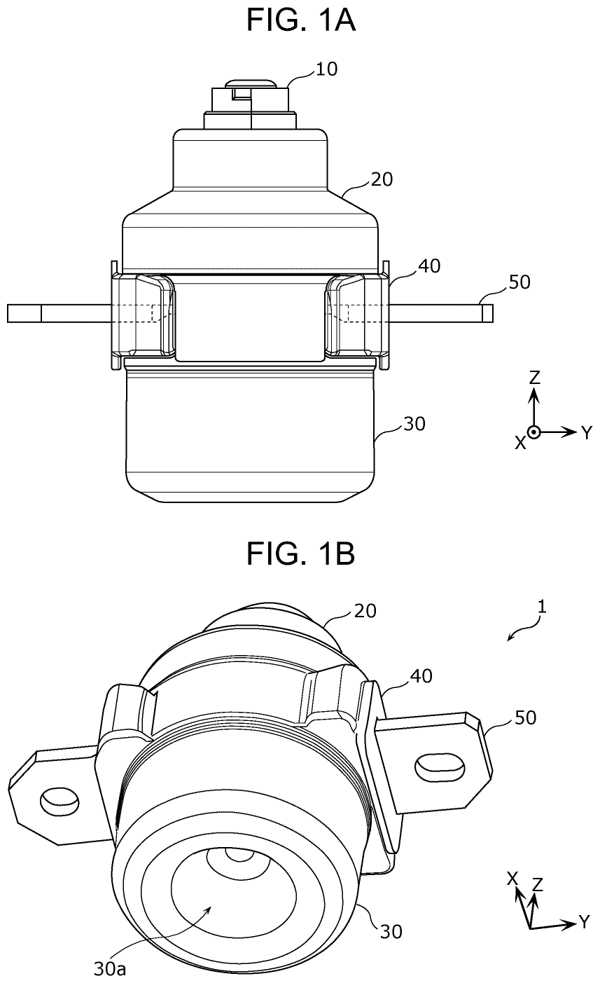

Hereinafter, the breaker device according to the present exemplary embodiment will be described with reference to FIG. 1A to FIG. 4.

### 1-1. Configuration of Breaker Device

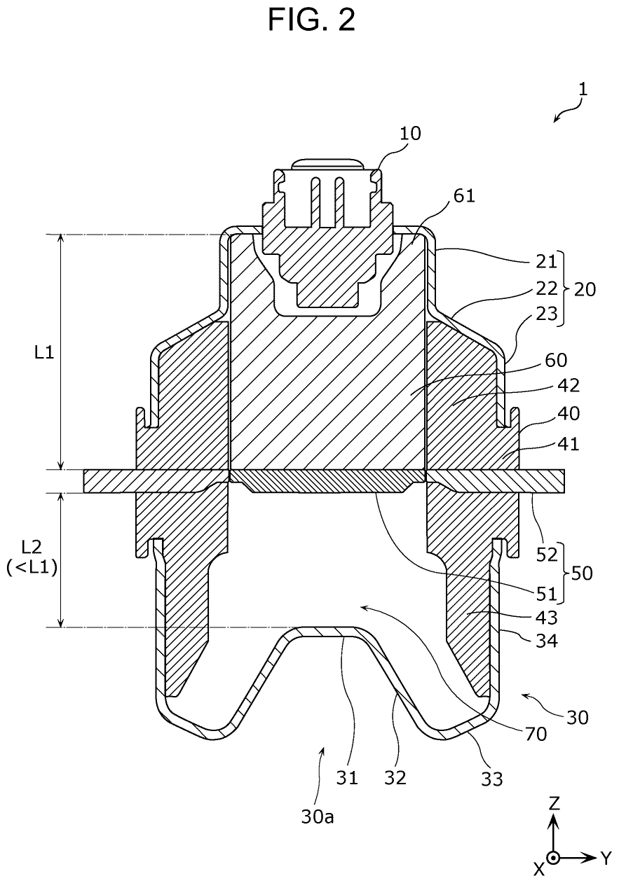

First, the configuration of the breaker device according to the present exemplary embodiment will be described with reference to FIG. 1A to FIG. 2. FIG. 1A is a front view illustrating breaker device 1 according to the present exemplary embodiment. FIG. 1B is a perspective view illustrating breaker device 1 according to the present exemplary embodiment. FIG. 2 is a cross-sectional view illustrating breaker device 1 according to the present exemplary embodiment. The front view is a diagram of breaker device 1 viewed in a direction perpendicular to the up-down direction, and FIG. 1A is a diagram of breaker device 1 viewed in the X-axis direction. The cross-sectional view is a diagram illustrating a cross-section of breaker device 1 cut along the YZ plane.

As illustrated in FIG. 1A to FIG. 2, breaker device 1 includes igniter 10, upper casing 20, lower casing 30, resin member 40, conductor 50, and pusher 60. Breaker device 1 is a device that is mounted on an object including an electrical circuit and operates to interrupt the electrical circuit when an anomaly occurs in the electrical circuit, a system, or the like in the object, to thereby prevent damage caused by the anomaly from becoming severe. For example, breaker device 1 is mounted on a vehicle, which is one example of the object, and is connected between a motor and a battery (for example, a lithium-ion battery) for driving the motor to interrupt the electrical connection between the motor and the battery for driving the motor at the time of emergency such as an abnormal time or the time of an accident. Note that the object may be other than a vehicle; examples of the object include, but are not limited to, a home appliance and a photovoltaic system.

Igniter 10 is an electric igniter including: a gunpower portion including an ignition charge; and a conducting pin for passing an electric current through the gunpowder portion. During operation, an operating current for igniting the ignition charge is supplied from an external power supply to the conducting pin, thus the ignition charge is ignited and burnt, and gas (combustion gas) is generated.

Igniter 10 is fixed to small-diameter portion 21 located at the top of upper casing 20.

Upper casing 20 and lower casing 30, which are members constituting the outer full of breaker device 1, house a portion of each of igniter 10, resin member 40, and conductor 50, and pusher 60. Space 70 extending in the up-down direction is formed inside upper casing 20 and lower casing 30. Space 70 is a space formed linearly so that pusher 60 can move therein. Pusher 60 is housed in an area of space 70 that is located at the upper end (on the positive side of the Z-axis) in the up-down direction (the Z-axis direction).

Each of upper casing 20 and lower casing 30 is formed of a metal such as stainless steel (SUS), but may be formed of other metals such as aluminum. The outer shape of each of upper casing 20 and lower casing 30 is, but not limited to, a circular column. Upper casing 20 and lower casing 30 are fixed using fastening members such as screws and rivets. Each of upper casing 20 and lower casing 30 is one example of the casing.

Upper casing 20, which is a cylinder member having the shape of a circular cylinder with a step, for example, is hollow inside. Upper casing 20 includes: small-diameter portion 21 located in an upper area; large-diameter portion 23 located in a lower area; and connecting portion 22 that connects these small-diameter and large-diameter portions. Small-diameter portion 21 and large-diameter portion 23 are coaxially disposed, and large-diameter portion 23 is larger in diameter than small-diameter portion 21.

Lower casing 30, which is a member having the shape of a hollow cylinder with a closed bottom, includes projecting portion 30a that protrudes upward. Specifically, lower casing 30 includes: leading end portion 31 and wall portion 32 that form projecting portion 30a; bottom portion 33, and side wall portion 34. Leading end portion 31, wall portion 32, bottom portion 33, and side wall portion 34 are integrally formed. Lower casing 30 is one example of the first holder.

Note that in the present specification, being integrally formed means that components are formed of the same material, that components are formed at the same time, and that components are the same object, for example.

Projecting portion 30a is located below separating portion 51 and configured so as to protrude upward. Projecting portion 30a is connected to one end of bottom portion 33 and protrudes upward (on the positive side of the Z-axis) from bottom portion 33. Projecting portion 30a is configured so as to deform downward by being pressed by pusher 60 that has moved downward by the gas generated by igniter 10. For example, projecting portion 30a is configured so as to undergo deformation such as leading end portion 31 moving downward, projecting portion 30a (leading end portion 31) being pressed and crushed, projecting portion 30a (leading end portion 31) being crushed and dented, the whole of projecting portion 30a being lowered, or projecting portion 30a being reduced in height. This means that projecting portion 30a has the function of absorbing the impact (stress) from pusher 60 by deformation.

Projecting portion 30a forms the recessed portion of lower casing 30 when breaker device 1 is viewed from the negative side of the Z-axis to the positive side of the Z-axis (viewed from below). Projecting portion 30a is exposed. In the present exemplary embodiment, projecting portion 30a is tapered upward, but the shape of projecting portion 30a is not limited to this tapered shape. Other shapes and configurations of projecting portion 30a will be described in “[Various Variations of Exemplary Embodiments]” below.

Leading end portion 31 is a part of projecting portion 30a that is in the shape of a flat plate located in an upper area. Leading end portion 31 is a portion that contacts separating portion 51 during the interrupting operation. Leading end portion 31, which takes the form of a surface, can receive the stress from pusher 60 on the surface and can therefore reduce stress concentration as compared to when leading end portion 31 is sharp.

Note that in the present specification, contact may represent direct contact between two members or may represent indirect contact between two members via another member disposed therebetween. For example, contact herein may represent direct contact between leading end portion 31 and separating portion 51 or may represent indirect contact between leading end portion 31 and separating portion 51 via another member disposed therebetween. For example, an arc-extinguishing material may be disposed between leading end portion 31 and separating portion 51 or separating portion 51 may be disposed between leading end portion 31 and pusher 60. Note that indirect contact means that stress can be transferred from one of leading end portion 31 and separating portion 51 to the other via another member.

Wall portion 32 is a part of projecting portion 30a that extends upward from bottom portion 33. Wall portion 32 is a part that connects leading end portion 31 and bottom portion 33 and is inclined at a predetermined angle with respect to leading end portion 31. Wall portion 32 is tapered (in the shape of a tapered circular cylinder with no bottom) toward leading end portion 31. For example, the shape of a cross-section of projecting portion 30a is a trapezoid. Since wall portion 32 is cylindrical, projecting portion 30a has an easily crushable configuration as compared to when projecting portion 30a is columnar, for example. Wall portion 32 is disposed coaxially with small-diameter portion 21 and large-diameter portion 23. Wall portion 32 forms the inner surface of the aforementioned recessed portion as viewed from below. Wall portion 32 is one example of the first wall portion.

Bottom portion 33 connects projecting portion 30a and side wall portion 34. In other words, projecting portion 30a and side wall portion 34 are connected via bottom portion 33. Bottom portion 33 has an outer surface and an inner surface each inclined upward from projecting portion 30a toward side wall portion 34. Bottom portion 33 is inclined in the direction opposite to the direction in which wall portion 32 is inclined. Bottom portion 33 is one example of the first bottom portion.

Side wall portion 34 is connected to the other end of bottom portion 33 and is formed so as to extend upward from bottom portion 33. Side wall portion 34 has the shape of a cylinder; in the present exemplary embodiment, side wall portion 34 has the shape of a circular cylinder. Side wall portion 34 is disposed coaxially with small-diameter portion 21 and large-diameter portion 23. The diameter of side wall portion 34 is equal to the diameter of large-diameter portion 23, for example.

Leading end portion 31, wall portion 32, bottom portion 33, and side wall portion 34 have the same thickness, but may have different thicknesses, for example.

Resin member 40 is a member that covers a part of conductor 50. Resin member 40 forms space 70. Resin member 40 includes embedding portion 41, first cylindrical portion 42, and second cylindrical portion 43.

Embedding portion 41 is a part of resin member 40 in which conductor 50 is embedded. Embedding portion 41 is partially exposed from the casing, for example. Embedding portion 41 has a through-hole in which conductor 50 (specifically, holding portion 52) is disposed.

First cylindrical portion 42, which is a part of resin member 40 that is disposed in the casing, is where pusher 60 is disposed during a non-interrupting operation (while no gas is generated by igniter 10). The inner diameter of first cylindrical portion 42 is less than the inner diameter of second cylindrical portion 43. Note that the position of pusher 60 illustrated in FIG. 2 indicates the initial position assumed during a non-interrupting operation.

Second cylindrical portion 43, which is a part of resin member 40 that is disposed in the casing, is a part located at a level below first cylindrical portion 42. The inner diameter of second cylindrical portion 43 is greater than the inner diameter of first cylindrical portion 42. Thus, the volume of the lower area of space 70 can be made large. This makes it possible to reduce an increase in the pressure inside the casing that is caused by the gas generated by igniter 10 and the following movement of pusher 60, meaning that the deformation of breaker device 1 can be minimized.

In this manner, pusher 60 moves in space 70 formed by first cylindrical portion 42 and second cylindrical portion 43. Note that first cylindrical portion 42 and second cylindrical portion 43 are not limited to having different inner diameters and may have the same inner diameter.

Conductor 50 is an electrically conductive metal body located in upper casing 20 and lower casing 30. When breaker device 1 is mounted on a predetermined electrical circuit, conductor 50 forms a part of said electrical circuit and is also referred to as a busbar. Conductor 50 is a flat member held on resin member 40 and disposed so as to cross the interior of each of upper casing 20 and lower casing 30. Conductor 50 includes separating portion 51 and holding portion 52.

Conductor 50 can be formed of a metal such as copper (Cu), for example. Note that conductor 50 may be formed of a metal other than copper or may be formed of an alloy of copper and another metal. For example, conductor 50 may contain manganese (Mn), nickel (Ni), platinum (Pt), or the like.

Separating portion 51, which is a part of conductor 50 to be cut off by pusher 60 under the pressure of the gas generated by igniter 10, is located below pusher 60 at the initial position.

Holding portion 52 is a part of conductor 50 that is held by resin member 40. Holding portion 52 is a part that does not overlap pusher 60 in plan view; for example, holding portion 52 is a part that overlaps resin member 40 and is a part located outside of the casing in plan view. Holding portion 52 remains held by resin member 40 even after separating portion 51 is cut off.

Pusher 60 is positioned below igniter 10 and disposed so as to be able to move downward and, for example, when an anomaly occurs, moves downward to cut conductor 50 and interrupt the flow of an electric current through the electrical circuit as an emergency measure. Pusher 60 is formed from an insulating member such as a synthetic resin, for example. In the present exemplary embodiment, pusher 60 is formed from nylon. Pusher 60 has the shape of a circular column with an outer diameter corresponding to the inner diameter of small-diameter portion 21 of upper casing 20. Pusher 60 includes recessed portion 61, and igniter 10 is disposed inside recessed portion 61. Note that the shape of pusher 60 is not limited to said shape and can be changed, as appropriate, according to the shape, etc., of each of upper casing 20 and lower casing 30. Recessed portion 61 is an upper portion of pusher 60 where a recess directed downward is provided. In the example illustrated in FIG. 2, recessed portion 61 is a portion with a lateral surface surrounded by small-diameter portion 21 in the state where breaker device 1 has not performed the interrupting operation (the state illustrated in FIG. 2).

Distance L2 between the leading end (for example, leading end portion 31) of projecting portion 30a and separating portion 51 before separating portion 51 is cut off from conductor 50 is less than vertical length L1 of pusher 60. In the present exemplary embodiment, there are no other members disposed between the leading end (for example, leading end portion 31) of projecting portion 30a and separating portion 51. This means that distance L2 is the length of a space (an air layer).

### 1-2. Interrupting Operation

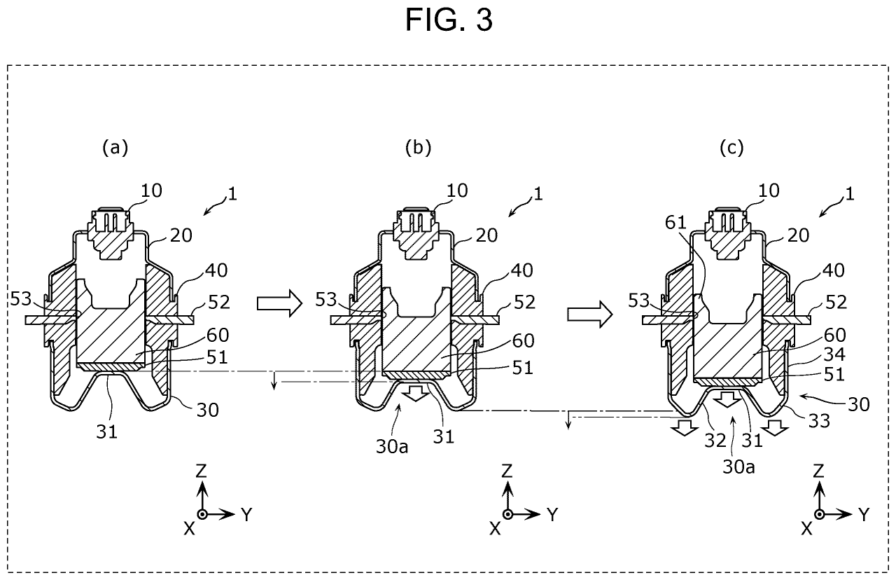

Next, the interrupting operation of breaker device 1 configured as described above will be described with reference to FIG. 3. FIG. 3 is a diagram for describing the interrupting operation of breaker device 1 according to the present exemplary embodiment. In FIG. 3, (a) is a cross-sectional view illustrating the state where pusher 60 is in contact (collision) with leading end portion 31 after separating portion 51 is cut off. In FIG. 3, (b) is a cross-sectional view illustrating the state where pusher 60 has further moved downward from the state illustrated in (a) in FIG. 3 and projecting portion 30a has deformed. In FIG. 3, (c) illustrates the state where pusher 60 has further moved downward from the state illustrated in (b) in FIG. 3 and in addition to projecting portion 30a, bottom portion 33 has deformed.

First, when igniter 10 operates, the upper surface (the pressure-receiving surface) of pusher 60 receives the pressure of energy from igniter 10, and thus pusher 60 moves downward at high speed from the initial position illustrated in FIG. 2, cuts off separating portion 51 from holding portion 52, and moves further downward at high speed integrally with cut-off separating portion 51. Thus, pusher 60 can cut conductor 50 forcibly and physically.

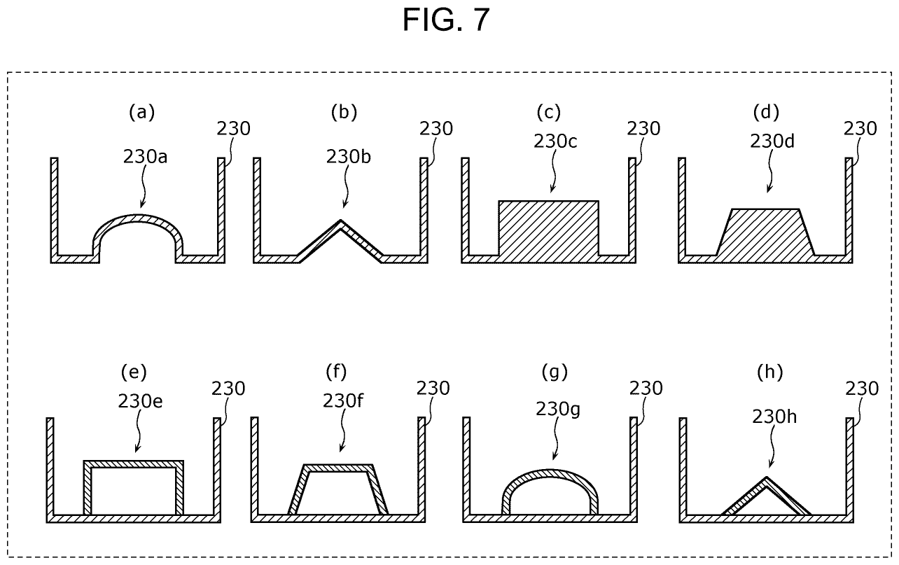

As illustrated in (a) in FIG. 3, pusher 60 cuts off separating portion 51 from conductor 50 by receiving the pressure of the gas generated by igniter 10, and after the cut-off, moves downward together with separating portion 51 and comes into contact with leading end portion 31 via separating portion 51. In the present exemplary embodiment, pusher 60 and separating portion 51 come into surface contact with each other, and separating portion 51 and leading end portion 31 come into surface contact with each other. As a result, it is possible to keep stress from being locally applied to pusher 60 when pusher 60 comes into contact with leading end portion 31 via separating portion 51, and thus it is possible to minimize damage to pusher 60. Note that the present exemplary embodiment describes an example where leading end portion 31 is a flat surface, but substantially the same advantageous effects are produced even when leading end portion 31 is a curved surface (for example, the shape illustrated in (a) in FIG. 7 to be described later).

Note that since distance L2 is less than length L1, the upper surface (the surface on the positive side of the Z-axis) of pusher 60 is located at a level above holding portion 52 in (a) in FIG. 3. As a result, after the interrupting operation, the distance between the pair of holding portions 52 on the electrical pathway can be increased and therefore, electric arc generation can be reduced. Thus, pusher 60 has the function of blocking an electric arc after interruption.

Next, as illustrated in (b) in FIG. 3, when pusher 60 further moves downward from the state illustrated in (a) in FIG. 3, projecting portion 30a deforms. Projecting portion 30a deforms downward by being pressed by pusher 60. Thus, projecting portion 30a can absorb the impact (stress) from pusher 60 by deformation. Furthermore, even when pusher 60 moves further downward, a part of pusher 60 (for example, at least a part of recessed portion 61) is located at a level above cut surface 53. As a result, the insulation distance between cut surfaces 53 of conductor 50 can be increased and thus, it is possible to reduce the occurrence of an electric arc when conductor 50 is cut.

Note that in the present specification, pressing means application of the stress from pusher 60 to projecting portion 30a. Pressing may mean directly applying stress by pusher 60 to projecting portion 30a or may mean indirectly applying stress by pusher 60 to projecting portion 30a via another member, for example.

Next, as illustrated in (c) in FIG. 3, when pusher 60 further moves downward from the state illustrated in (b) in FIG. 3, bottom portion 33 further deforms downward, and pusher 60 stops. Even in this state, a part of pusher 60 (for example, at least a part of recessed portion 61) is located at a level above cut surface 53. As a result, the insulation distance between cut surfaces 53 of conductor 50 can be increased and thus, it is possible to reduce the occurrence of an electric arc when conductor 50 is cut.

Furthermore, since bottom portion 33 is connected to projecting portion 30a, bottom portion 33 can deform when pusher 60 presses projecting portion 30a to at least a predetermined extent. Thus, lower casing 30 according to the present exemplary embodiment has such a structure that when the pusher presses projecting portion 30a, bottom portion 33 deforms. For example, bottom portion 33 is configured to make a downward movement or the like. Since projecting portion 30a and bottom portion 33 are formed of the same material, bottom portion 33 is likely to deform as compared to when bottom portion 33 is formed of a material harder than the material of projecting portion 30a. As a result of bottom portion 33 deforming together with projecting portion 30a, each of projecting portion 30a and bottom portion 33 can absorb the impact (stress) from pusher 60.

Thus, by including projecting portion 30a in breaker device 1, it is possible to keep the bottom portion of breaker device 1 from undergoing significant deformation. For example, if the breaker device does not include projecting portion 30a and the bottom portion is flat, the stress from pusher 60 cannot be absorbed enough, meaning that the bottom portion is expected to undergo signification deformation, as compared to when the breaker device includes projecting portion 30a. Furthermore, with such a configuration, if the bottom portion is formed of a hard material in order to minimize the deformation of the bottom portion, there is a risk that the pusher may be damaged by the stress (impact) received from the bottom portion.

In contrast, in breaker device 1 according to the present exemplary embodiment, projecting portion 30a can absorb the stress from pusher 60 and therefore, the deformation of bottom portion 33 can be minimized as compared to when the bottom portion is flat. Thus, breaker device 1 can reduce damage to other devices or the like that may be caused by significant deformation of the casing occurring as a result of operation. Furthermore, projecting portion 30a deforms due to the stress (impact) received from pusher 60 and thus mitigates the impact on bottom portion 33, allowing for reduced damage to bottom portion 33. Moreover, the impact that bottom portion 33 receives from pusher 60 can also be mitigated, allowing for reduced damage to pusher 60.

Furthermore, since projecting portion 30a is formed as a part of lower casing 30, the deformation of bottom portion 33 can be minimized without adding a new member for absorbing the stress from pusher 60. Thus, it is possible to realize breaker device 1 in which the deformation of the casing is minimized while the increases in cost and the number of components are limited.

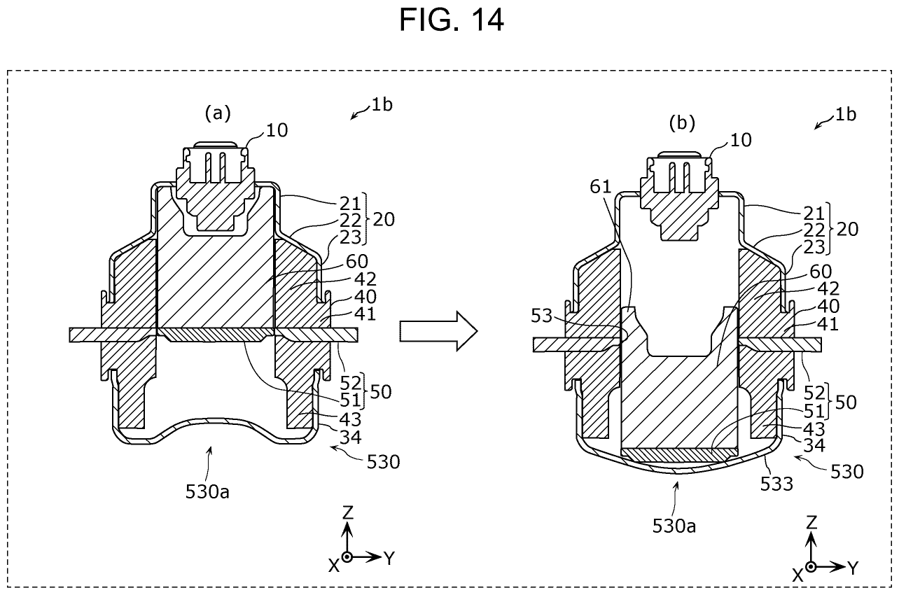

As described above, breaker device 1 may be configured so that when pusher 60 presses projecting portion 30a, bottom portion 33 deforms. Furthermore, breaker device 1 may be configured so that the protruding direction of the projecting portion pressed by pusher 60 is reversed (for example, refer to FIG. 14, etc., to be described later). Note that the deformation of bottom portion 33 is not essential; projecting portion 30a may be configured so that pusher 60 stops without the deformation of bottom portion 33. Furthermore, when pusher 60 presses projecting portion 30a, side wall portion 34 may also deform.

### 1-3. Manufacturing Method

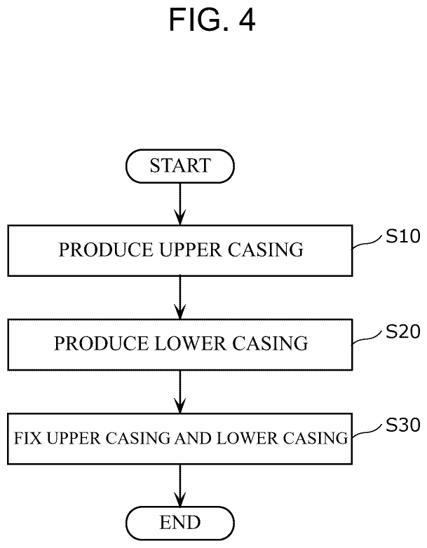

Next, the method for manufacturing breaker device 1 configured as described above will be described with reference to FIG. 4. FIG. 4 is a flowchart illustrating a manufacturing process of breaker device 1 according to the present exemplary embodiment.

As illustrated in FIG. 4, upper casing 20 is produced by molding or the like (S10), and lower casing 30 is produced by molding or the like (S20). Note that Step S10 may be performed after Step S20.

Projecting portion 30a is formed at the same time as lower casing 30 is produced by molding. For example, when projecting portion 30a is tapered upward, a part of projecting portion 30a that is configured at a right angle can be reduced and thus, the manufacture of lower casing 30 is facilitated. Furthermore, when the connecting portion between projecting portion 30a and bottom portion 33 is not configured at a right angle, the manufacture of lower casing 30 is facilitated.

Next, upper casing 20 and lower casing 30 are fixed (S30). For example, upper casing 20 and lower casing 30 are fixed without gaps by fastening members or the like in the state where igniter 10, resin member 40, conductor 50, and pusher 60 are housed in the casings. As a result, breaker device 1 described above is produced.

### Embodiment 2

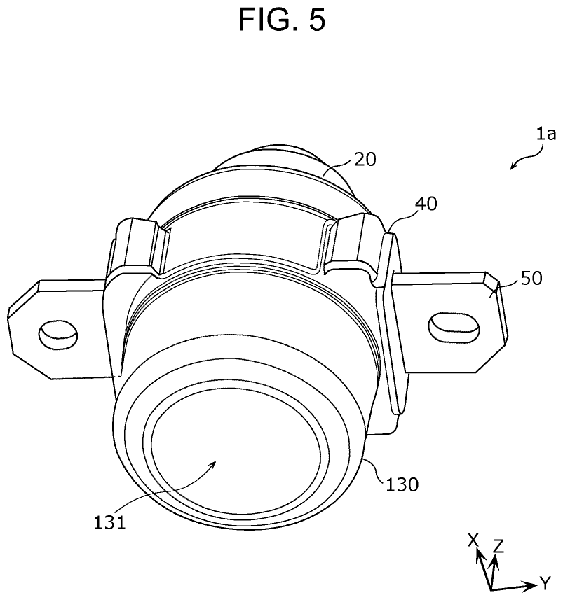

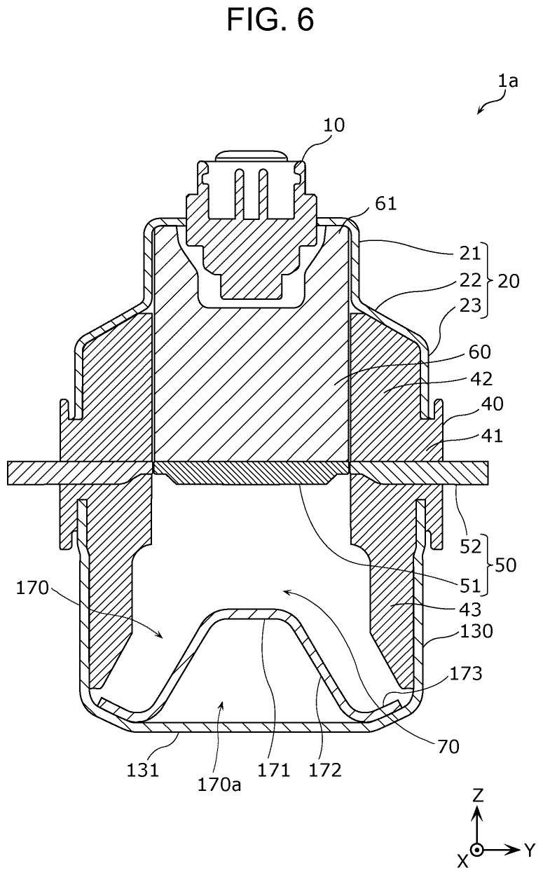

Hereinafter, the configuration of the breaker device according to the present exemplary embodiment will be described with reference to FIG. 5 to FIG. 6. Note that the following description will focus on differences from Embodiment 1, and description of details that are the same as or similar to those described in Embodiment 1 will be omitted or simplified.

FIG. 5 is a perspective view illustrating breaker device 1a according to the present exemplary embodiment. FIG. 6 is a cross-sectional view illustrating breaker device 1a according to the present exemplary embodiment. Breaker device 1a according to the present exemplary embodiment is different from breaker device 1 according to Embodiment 1 in that the projecting portion is provided separately from the casing.

As illustrated in FIG. 5 to FIG. 6, breaker device 1a includes igniter 10, upper casing 20, lower casing 130, resin member 40, conductor 50, and pusher 60. Furthermore, projecting member 170 is fixed (for example, joined) to lower casing 130.

Lower casing 130 is a member having the shape of a hollow cylinder with a closed bottom. Lower casing 130 includes bottom portion 131 in the shape of a flat plate. For example, when breaker device 1a is viewed from below, the recessed portion is not formed, and the lower surface is flat.

Projecting member 170 is located below separating portion 51 and is configured so as to protrude upward from the inner surface of lower casing 130. In the present exemplary embodiment, projecting member 170 is tapered upward, but the shape of projecting member 170 is not limited to this tapered shape. Projecting member 170 includes leading end portion 171, wall portion 172, and flange portion 173. Leading end portion 171 and wall portion 172 form projecting portion 170a.

Leading end portion 171 is a part of projecting portion 170a that is in the shape of a flat plate located in an upper area. Leading end portion 171 is a portion that contacts separating portion 51 during the interrupting operation.

Wall portion 172 connects leading end portion 171 and flange portion 173. Wall portion 172 is tapered (in the shape of a tapered circular cylinder with no bottom) toward leading end portion 171. Wall portion 172 is disposed coaxially with small-diameter portion 21 and large-diameter portion 23.

Flange portion 173, which is a portion for fixing projecting portion 170a to lower casing 130, is in the shape of a flat plate provided protruding laterally from a lower end of wall portion 172. Flange portion 173 and lower casing 130 (for example, bottom portion 131) are joined together by welding or the like. Thus, projecting portion 170a is fixed to lower casing 130.

In such breaker device 1a, projecting portion 170a can absorb the downward stress from pusher 60 and thus, it is possible to minimize the deformation of lower casing 130.

As described above, breaker device 1a may have a configuration in which lower casing 130 and projecting portion 170a are formed as separate bodies and integrally joined together by welding, fastening members, or the like. Note that the method for fixing lower casing 130 and projecting portion 170a is not limited to welding and fastening members and may be any other methods.

### Various Variations of Exemplary Embodiments

Hereinafter, various variations applicable to each of the exemplary embodiments or one of the exemplary embodiments will be described with reference to FIG. 7 to FIG. 12.

FIG. 7 is a cross-sectional view illustrating the first example of various variations of lower casing 230 according to each exemplary embodiment. With reference to FIG. 7, various variations of the configuration of the projecting portion will be described. In FIG. 7, (a) and (b) are variations of lower casing 30 according to Embodiment 1, and (c) and (d) are variations of lower casing 130 according to Embodiment 2.

As illustrated in (a) in FIG. 7, the shape of a cross-section of projecting portion 230a may be a semicircle. Projecting portion 230a may be dome-shaped, for example.

As illustrated in (b) in FIG. 7, the shape of a cross-section of projecting portion 230b may be a triangle. Projecting portion 230b may be cone shaped, for example.

Furthermore, the projecting portion may have a solid structure in which the interior is filled with a material.

As illustrated in (c) in FIG. 7, the shape of a cross-section of projecting portion 230c may be a solid rectangle. Projecting portion 230c may be cuboid shaped, for example. In this case, projecting portion 230c is formed of a material (a resin, an aluminum alloy, or the like) that is crushed when pressed by the pusher.

As illustrated in (d) in FIG. 7, the shape of a cross-section of projecting portion 230d may be a solid trapezoid. Projecting portion 230d may be truncated cone shaped, for example. In this case, projecting portion 230d is formed of a material (a resin, an aluminum alloy, or the like) that is crushed when pressed by the pusher.

Furthermore, the projecting portion may have a hollow structure that has a cavity inside, or an arc-extinguishing material, a coolant gas, or the like may fill the cavity.

As illustrated in (e) in FIG. 7, the shape of a cross-section of projecting portion 230e may be a hollow rectangle. In this case, projecting portion 230e is fixed to lower casing 230 as in Embodiment 2.

As illustrated in (f) in FIG. 7, the shape of a cross-section of projecting portion 230f may be a hollow trapezoid without the flange portion. In this case, projecting portion 230f is fixed to lower casing 230 as in Embodiment 2.

As illustrated in (g) in FIG. 7, the shape of a cross-section of projecting portion 230g may be a hollow semicircle. In this case, projecting portion 230g is fixed to lower casing 230 as in Embodiment 2.

As illustrated in (h) in FIG. 7, the shape of a cross-section of projecting portion 230h may be a hollow triangle. In this case, projecting portion 230h is fixed to lower casing 230 as in Embodiment 2.

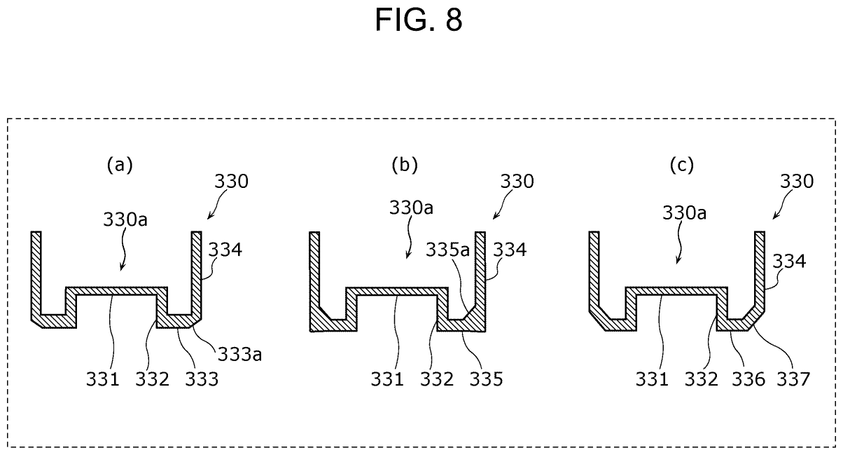

Next, various variations of a portion connecting the projecting portion and the side wall portion will be described with reference to FIG. 8. FIG. 8 is a cross-sectional view illustrating the second example of various variations of the lower casing according to each exemplary embodiment. In FIG. 8, (a) to (c) are variations of lower casing 30 according to Embodiment 1.

As illustrated in (a) in FIG. 8, lower casing 330 includes leading end portion 331, wall portion 332, bottom portion 333, and side wall portion 334. Leading end portion 331 and wall portion 332 form projecting portion 330a. Note that the shape of projecting portion 330a is not limited to the shape described below and may be that illustrated in FIG. 2 or (a) or (b) in FIG. 7, for example.

Leading end portion 331 is a part of projecting portion 330a that is in the shape of a flat plate.

Wall portion 332 is a portion that connects leading end portion 331 and bottom portion 333 and is disposed parallel to side wall portion 334. Note that lower casing 330 may include wall portion 32 instead of wall portion 332.

Bottom portion 333 connects wall portion 332 and side wall portion 334. Bottom portion 333 may include, on at least a part of an outer surface, inclined surface 333a that is inclined upward from projecting portion 330a toward side wall portion 334. For example, at least a part of bottom portion 333 just mentioned is configured so as to be further reduced in thickness toward side wall portion 334. Inclined surface 333a may be formed on the entire outer surface of bottom portion 333. Since bottom portion 333 includes a part inclined upward, projecting portion 330a makes it possible to minimize the deformation of the outer shape of the casing. The minimizing of the deformation herein means that even when inclined surface 333a deforms, deformation is minimized that causes inclined surface 333a to be positioned at a level below bottom portion 333 or on the side of side wall portion 334.

As illustrated in (b) in FIG. 8, bottom portion 335 may include, on at least a part of an inner surface, inclined surface 335a that is inclined upward from projecting portion 330a toward side wall portion 334. For example, at least a part of bottom portion 335 just mentioned is configured so as to be further increased in thickness toward side wall portion 334. Inclined surface 335a may be formed on the entire inner surface of bottom portion 335. With inclined surface 335a, it is possible to disperse pressure that is applied to the inside of the casing; thus, projecting portion 330a makes it possible to minimize the deformation of the outer shape of the casing.

As illustrated in (c) in FIG. 8, lower casing 330 includes leading end portion 331, wall portion 332, connecting portion 336, inclined portion 337, and side wall portion 334. Connecting portion 336 and inclined portion 337 form the bottom portion. Since the inner surface and the outer surface of inclined portion 337 are inclined, projecting portion 330a can disperse the internal pressure of lower casing 330 and can minimize the deformation of the outer shape of the casing.

Connecting portion 336 connects projecting portion 330a and inclined portion 337.

Inclined portion 337 may connect connecting portion 336 and side wall portion 334, and each of the outer surface and the inner surface of inclined portion 337 may be inclined upward from connecting portion 336 toward side wall portion 334. Inclined portion 337 is inclined with respect to leading end portion 331, for example.

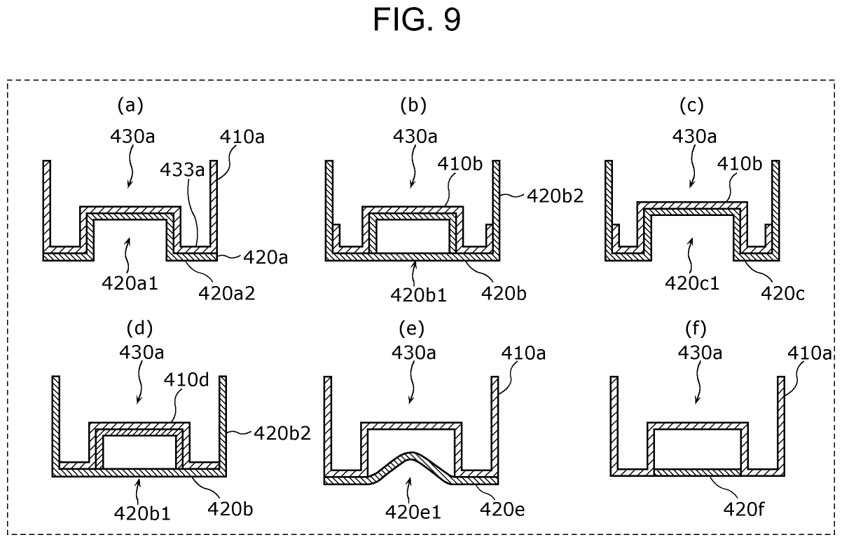

Next, various variations in which at least a part of the projecting portion has a double structure will be described with reference to FIG. 9. FIG. 9 is a cross-sectional view illustrating the third example of various variations of the lower casing according to each exemplary embodiment. As illustrated in (a) to (f) in FIG. 9, the breaker device may include an additional casing (additional casings 420a to 420f) that is provided separately from the lower casing (lower casings 410a, 410b, 410d) and is located below said lower casing.

Each of additional casings 420a to 420f is formed of the same member (for example, SUS) as the lower casing, for example, but this is not limiting. Each of additional casings 420a to 420f constitutes the outer hull of a part of the casing. Each of additional casings 420a to 420f is at least partially exposed. Each of additional casings 420a to 420f is one example of the second holder.

Note that being located below the lower casing may indicate at least a part being located below the lower casing or may indicate being located below the projecting portion of the lower casing.

As illustrated in (a) in FIG. 9, lower casing 410a includes projecting portion 430a, and the breaker device may include additional casing 420a. Additional casing 420a has a shape corresponding to projecting portion 430a and bottom portion 433a. Specifically, additional casing 420a is in contact (surface contact) with the outer surface of projecting portion 430a and bottom portion 433a. In other words, additional casing 420a includes: projecting portion 420a1 (one example of the second projecting portion) protruding upward; and bottom portion 420a2 (one example of the second bottom portion). Projecting portion 420a1 includes a second wall portion extending upward from bottom portion 420a2, and said second wall portion is disposed along the wall portion (first wall portion) of projecting portion 430a. In this case, projecting portion 420a1 is fixed to lower casing 410a as in Embodiment 2. Note that when projecting portion 420a1 and lower casing 410a are separate bodies, projecting portion 420a1 and lower casing 410a are preferably joined together by welding or the like.

In such a breaker device, the thickness of each of the projecting portion and the bottom portion can be set greater than the thickness of the side wall portion and thus, it is possible to effectively minimize the deformation of lower casing 410a.

As illustrated in (b) in FIG. 9, additional casing 420b includes hollow projecting portion 420b1 and side wall portion 420b2. Side wall portion 420b2 constitutes the outer full of the breaker device. In other words, lower casing 410b is housed inside additional casing 420b. Lower casing 410b includes projecting portion 430a. A part of lower casing 410b is provided along side wall portion 420b2 so as to also contact said side wall portion 420b2.

Note that each of lower casing 410b and additional casing 420b may be made from a metal. Furthermore, when projecting portion 420b1 and lower casing 410b are separate bodies, projecting portion 420b1 (or additional casing 420b) and lower casing 410b are preferably joined together by welding or the like.

As illustrated in (c) in FIG. 9, additional casing 420c may include projecting portion 420c1 that is a recessed portion as viewed from below.

Note that each of lower casing 410b and additional casing 420c may be made from a metal. Furthermore, when projecting portion 420c1 and lower casing 410b are separate bodies, projecting portion 420c1 (or additional casing 420c) and lower casing 410b are preferably joined together by welding or the like.

As illustrated in (d) in FIG. 9, lower casing 410d may be configured by removing a part of lower casing 410b illustrated in (b) in FIG. 9 that extends along side wall portion 420b2.

Note that each of lower casing 410d and additional casing 420b may be made from a metal. Furthermore, when projecting portion 420b1 and lower casing 410d are separate bodies, projecting portion 420b1 (or additional casing 420b) and lower casing 410d are preferably joined together by welding or the like.

As illustrated in (a) to (d) in FIG. 9, the additional casing may be provided along the lower casing. For example, the first projecting portion and the second projecting portion may be disposed on top of each other.

Furthermore, as illustrated in (e) in FIG. 9, additional casing 420e may include projecting portion 420e1 different in shape from projecting portion 430a of lower casing 410a. Projecting portion 420e1 is in the form of a mountain, for example, but this is not limiting. Projecting portion 420e1 is located below projecting portion 430a and is not in contact with projecting portion 430a. When projecting portion 430a deforms downward, projecting portion 420e1 comes into contact with projecting portion 430a.

Note that each of lower casing 410a and additional casing 420e may be made from a metal. Furthermore, when projecting portion 420e1 and lower casing 410a are separate bodies, projecting portion 420e1 (or additional casing 420e) and lower casing 410a are preferably joined together by welding or the like.

As illustrated in (f) in FIG. 9, additional casing 420f may be disposed so as to cover an opening formed by projecting portion 430a. For example, additional casing 420f may be a plate-shaped member.

Note that each of lower casing 410a and additional casing 420f may be made from a metal. Furthermore, when additional casing 420f and lower casing 410a are separate bodies, additional casing 420f and lower casing 410a are preferably joined together by welding or the like.

With the configuration illustrated in FIG. 9, the additional casing can receive (absorb) stress (impact) that the lower casing has failed to receive (has not completely absorbed), for example. For example, the projecting portion (second projecting portion) of the additional casing can receive stress that the projecting portion (first projecting portion) of the lower casing has failed to receive. The lower casing can absorb at least part of the stress from pusher 60 and thus, it is possible to minimize the deformation of the additional casing. As a result, it is possible to effectively minimize the deformation of the breaker device such as bulging of the outer shape of the breaker device.

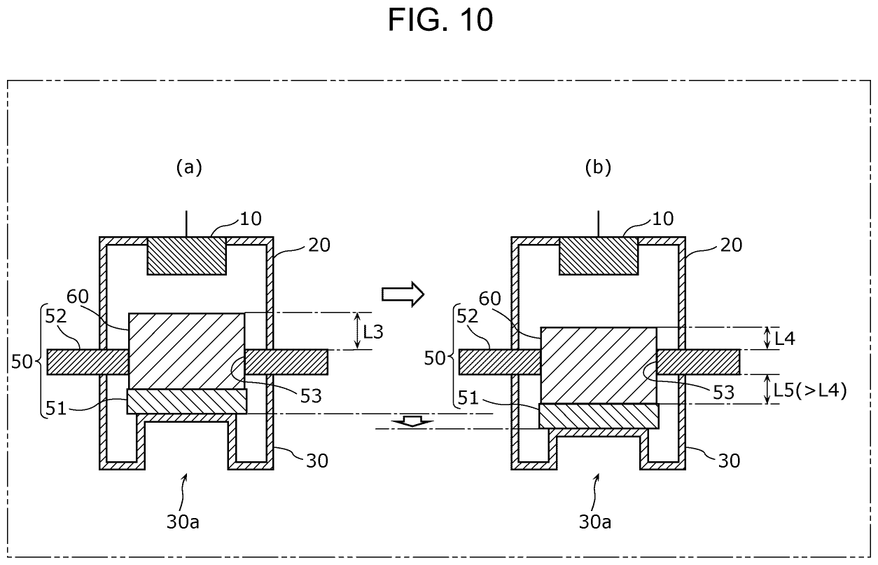

Next, various configurations of the breaker device will be described further with reference to FIG. 10 to FIG. 14. FIG. 10 is a cross-sectional view illustrating the first example of a variation of the breaker device according to each exemplary embodiment. Note that in FIG. 10, in order to simply show the positional relationship of holding portion 52, illustration of resin member 40 that covers conductor 50 (holding portion 52) is omitted. In FIG. 10 to FIG. 12, the shapes, etc., of structural elements are schematically illustrated.

As illustrated in (a) in FIG. 10, at a point in time when separating portion 51 comes into contact with projecting portion 30a by being pressed by pusher 60 after interruption, length L3 between the upper surface of conductor 50 and the upper end surface of pusher 60 is greater than zero. The upper surface of conductor 50 is located at a level above cut surface 53 of holding portion 52. Pusher 60 may be configured so that the upper end of pusher 60 is located at a level above cut surface 53 between holding portion 52 and separating portion 51 after pusher 60 cuts off separating portion 51. For example, pusher 60 may have length L1 such that at a point in time when separating portion 51 comes into contact with projecting portion 30a, the upper end of pusher 60 is located at a level above cut surface 53.

Furthermore, pusher 60 may be configured so that after pusher 60 cuts off separating portion 51, presses projecting portion 30a downward, and stops, distance L5 between the lower end of pusher 60 and the lower end of cut surface 53 of holding portion 52 is greater than or equal to distance L4 between the upper end surface of pusher 60 and the upper end of cut surface 53 of holding portion 52.

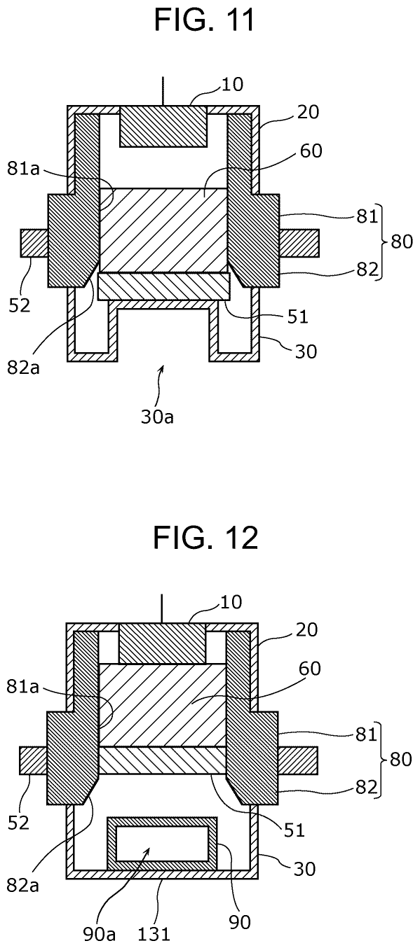

Next, a variation of a resin member included in the breaker device will be described with reference to FIG. 11. FIG. 11 is a cross-sectional view illustrating the second example of a variation of the breaker device according to each exemplary embodiment.

As illustrated in FIG. 11, resin member 80 includes: first cylindrical portion 81 in which at least a part of pusher 60 at the initial position is located; and second cylindrical portion 82 located at a level below first cylindrical portion 81. First cylindrical portion 81 and second cylindrical portion 82 are coaxially disposed, and second cylindrical portion 82 has a greater inner diameter than first cylindrical portion 81.

First cylindrical portion 81 has inner surface 81a. Inner surface 81a is disposed facing the side surface of pusher 60 in a cross-sectional view. In the cross-sectional view, the pair of inner surfaces 81a are opposite to each other.

Second cylindrical portion 82 has inner surface 82a. Inner surface 82a is inclined so as to have a greater inner diameter downward. In a cross-sectional view, the pair of inner surfaces 82a are tapered with the inner diameter reduced upward.

For example, resin member 80 may be configured so that after pusher 60 presses projecting portion 30a downward and stops, the upper end of pusher 60 is adjacent to first cylindrical portion 81 and the lower end of pusher 60 is adjacent to second cylindrical portion 82.

Next, a variation of the projecting portion will be described with reference to FIG. 12. FIG. 12 is a cross-sectional view illustrating the third example of a variation of the breaker device according to each exemplary embodiment.

As illustrated in FIG. 12, the breaker device includes hollow member 90 that is located below separating portion 51 in the casing and includes hollow portion 90a that is hollow inside, and separating portion 51 is located below pusher 60. Hollow member 90 is placed on the inner surface of bottom portion 131, for example. Note that hollow member 90 is not limited to contacting bottom portion 131; for example, it is sufficient that hollow member 90 be fixed between separating portion 51 and bottom portion 131.

Hollow portion 90a is sealed, and an arc-extinguishing material such as a non-combustible gas or liquid that extinguishes an electric arc may be enclosed in hollow portion 90a. In this case, hollow member 90 is configured so that the stress from pusher 60 allows communication between hollow portion 90a and space 70. For example, hollow member 90 has strength such that the stress from pusher 60 allows communication between hollow portion 90a and space 70.

In such a breaker device, it is only necessary to place hollow member 90 in the casing, meaning that the breaker device is easily manufactured.

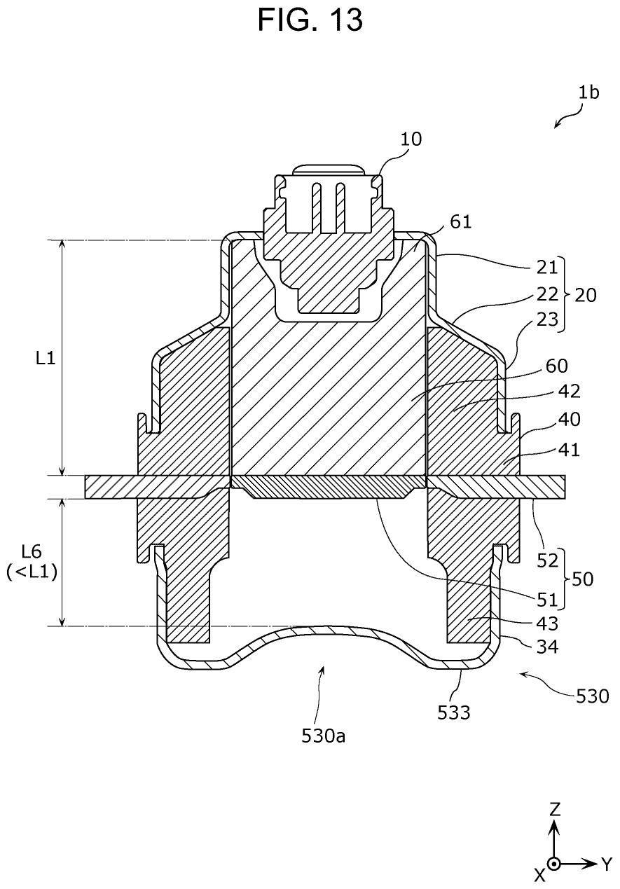

Next, a variation of the projecting portion will be described with reference to FIG. 13 and FIG. 14. First, the configuration of breaker device 1b in the fourth example will be described with reference to FIG. 13. FIG. 13 is a cross-sectional view illustrating the fourth example of a variation of breaker device 1b according to each exemplary embodiment.

As illustrated in FIG. 13, breaker device 1b includes lower casing 530 instead of lower casing 30 in breaker device 1 according to Embodiment 1.

Lower casing 530 includes projecting portion 530a that protrudes upward. Specifically, lower casing 530 includes projecting portion 530a, bottom portion 533, and side wall portion 34. Projecting portion 530a, bottom portion 533, and side wall portion 34 are integrally formed. Lower casing 530 is one example of the first holder.

Projecting portion 530a is located below separating portion 51 and configured so as to protrude upward. Projecting portion 530a is connected to one end of bottom portion 533 and protrudes upward (on the positive side of the Z-axis) from bottom portion 533. Furthermore, projecting portion 530a includes a portion in the shape of a flat plate in an upper area.

Projecting portion 530a is configured so as to deform downward by being pressed by pusher 60 that has moved downward by the gas generated by igniter 10. Projecting portion 530a has the function of absorbing the impact (stress) from pusher 60 by deformation.

Bottom portion 533 connects projecting portion 530a and side wall portion 34. In other words, projecting portion 530a and side wall portion 34 are connected via bottom portion 533. Bottom portion 533 is provided so as to extend in the Y-axis direction. Bottom portion 533 is one example of the first bottom portion.

In such lower casing 530, when pressed downward by pusher 60, projecting portion 530a deforms so that the protruding direction thereof is reversed (refer to (b) in FIG. 14 to be described later). The material and shape of projecting portion 530a are not particularly limited as long as the material and shape allow reversal of the protruding direction. Examples of the material of projecting portion 530a include a metal such as stainless steel (SUS) or aluminum.

Distance L6 between the leading end (the end on the positive side of the Z-axis) of projecting portion 530a and separating portion 51 before separating portion 51 is cut off from conductor 50 is less than vertical length L1 of pusher 60.

The interrupting operation of breaker device 1b configured as described above will be described with reference to FIG. 14. FIG. 14 is a diagram for describing the interrupting operation of breaker device 1b according to the fourth example of the variation.

In FIG. 14, (a) is a cross-sectional view of breaker device 1b in the state where breaker device 1b has not performed the interrupting operation (pusher 60 is at the initial position). The configuration illustrated in (a) in FIG. 14 is substantially the same as that illustrated in FIG. 13.

In FIG. 14, (b) is a cross-sectional view illustrating the state where projecting portion 530a has deformed downward as a result of pusher 60 further moving downward from the state where pusher 60 is in contact (collision) with projecting portion 530a. When pressed downward by pusher 60, projecting portion 530a deforms so that the protruding direction thereof is reversed. Furthermore, when pressed downward by pusher 60, not only projecting portion 530a, but also bottom portion 533 deforms downward.

In such lower casing 530, the shape thereof that results from downward deformation can be adjusted according to the shape, length, etc., of each of projecting portion 530a and bottom portion 533; thus, it is possible to keep unexpected level of downward deformation from occurring when pressed downward by pusher 60. Furthermore, since kinetic energy of pusher 60 is consumed in reversal of the protruding direction of projecting portion 530a, it is possible to rapidly reduce the speed of pusher 60. In other words, lower casing 530 can effectively absorb the stress from pusher 60 because the protruding direction of projecting portion 530a is reversed.

### Other Embodiments

The breaker devices according to one or more aspects have been described thus far based on the exemplary embodiments, but the present disclosure is not limited to these exemplary embodiments. Various modifications to the present exemplary embodiments and forms configured by combining structural elements in different exemplary embodiments that can be conceived by those skilled in the art may be included within the present disclosure as long as these do not depart from the essence of the present disclosure.

For example, the above exemplary embodiments describe examples in which the casing is made from a metal, but this is not limiting; for example, at least one of the lower casing and the additional casing included in the casing may be made from a resin with deformation properties.

Furthermore, the above exemplary embodiments describe examples in which one projecting portion is provided, but two or more projecting portions may be provided.

The order of the steps in the method for manufacturing the breaker device described in the above exemplary embodiments may be changed. Furthermore, the steps in the method for manufacturing the breaker device described in the above exemplary embodiments may be performed in a single step or may be performed in separate steps. Note that the phrase “the steps are performed in a single step” is intended to include a situation in which the steps are performed using a single device, a situation in which the steps are sequentially performed, and a situation in which the steps are performed at the same location. The term “separate steps” is intended to include a situation in which the steps are performed using separate devices, a situation in which the steps are performed at different times (for example, on different dates), and a situation in which the steps are performed at different locations.

### INDUSTRIAL APPLICABILITY

The present disclosure is useful in breaker devices, etc., that are disposed in an electrical circuit.

### REFERENCE SIGNS LIST

1, 1a, 1b breaker device
10 igniter
20 upper casing
21 small-diameter portion
22 connecting portion
23 large-diameter portion
30, 130, 230, 330, 410a, 410b, 410d, 530 lower casing (first holder)
30a, 170a, 230a, 230b, 230c, 230d, 230e, 230f, 230g, 230h, 330h, 330a, 430a, 530a projecting portion (first projecting portion)
31, 171, 331 leading end portion
32, 172, 332 wall portion
33, 131, 333, 335, 433a, 533 bottom portion (first bottom portion)
34, 334, 420b2 side wall portion
40, 80 resin member
41 embedding portion
42, 81 first cylindrical portion
43, 82 second cylindrical portion
50 conductor
51 separating portion
52 holding portion
53 cut surface
60 pusher
61 recessed portion
70 space
81a, 82a inner surface
90 hollow member
90a hollow portion
170 projecting member
173 flange portion
333a, 335a inclined surface
336 connecting portion
337 inclined portion
420a, 420b, 420c, 420e, 420f additional casing (second holder)
420a1, 420b1, 420c1, 420e1 projecting portion (second projecting portion)
420a2 bottom portion (second bottom portion)
L1, L3 length
L2, L4, L5, L6 distance

1. A breaker device comprising:
a casing including a first projecting portion;
an igniter that generates gas;
a pusher located below the igniter; and
a conductor including a separating portion located inside the casing and below the pusher, the separating portion being to be cut off by the pusher under pressure of the gas generated by the igniter, wherein
the first projecting portion of the casing is located below the separating portion and protrudes upward, and
the first projecting portion of the casing deforms downward by being pressed by the pusher.

2. The breaker device according to claim 1, wherein
the first projecting portion of the casing is tapered upward.

3. The breaker device according to claim 1, wherein
a distance between a leading end portion of the first projecting portion of the casing and the separating portion is less than a vertical length of the pusher before the separating portion is cut off from the conductor.

4. The breaker device according to claim 1, wherein
the casing includes a first holder,
the first holder includes:
a first bottom portion; and
the first projecting portion protruding upward from the first bottom portion, and
when the pusher presses the first projecting portion, the first bottom portion of the first holder deforms.

5. The breaker device according to claim 4, wherein
the first projecting portion includes a first wall portion extending upward from the first bottom portion, and
the first wall portion is cylindrical.

6. The breaker device according to claim 4, wherein
the first projecting portion includes a first wall portion extending upward from the first bottom portion,
the first holder includes a recessed portion as viewed from below, and
the first wall portion of the first projecting portion forms an inner surface of the recessed portion.

7. The breaker device according to claim 6, wherein
the first holder further includes a side wall portion,
the side wall portion and the first projecting portion are connected via the first bottom portion, and
when the pusher presses the first projecting portion of the casing, the side wall portion of the first holder deforms.

8. The breaker device according to claim 6, wherein
the first holder further includes a side wall portion,
the side wall portion and the first projecting portion are connected via the first bottom portion, and
at least a part of an outer surface of the first bottom portion is inclined upward from the first projecting portion toward the side wall portion.

9. The breaker device according to claim 6, wherein
the first holder further includes a side wall portion,
the side wall portion and the first projecting portion are connected via the first bottom portion, and
at least a part of an inner surface of the first bottom portion is inclined upward from the first projecting portion toward the side wall portion.

10. The breaker device according to claim 6, wherein
the first holder further includes a side wall portion,
the side wall portion and the first projecting portion are connected via the first bottom portion, and
the first bottom portion includes:
a connecting portion connected to the first projecting portion; and
an inclined portion that connects the connecting portion and the side wall portion and includes an outer surface and an inner surface each inclined upward from the connecting portion toward the side wall portion.

11. The breaker device according to claim 5, wherein
the casing further includes a second holder,
the second holder is located below the first holder, and
the first holder and the first projecting portion are integrally formed.

12. The breaker device according to claim 11, wherein
the second holder includes a second projecting portion protruding upward, and
the second projecting portion is located below the first projecting portion of the first holder.

13. The breaker device according to claim 12, wherein
the second holder includes:
a second bottom portion; and
the second projecting portion protruding upward from the second bottom portion,
the second projecting portion includes a second wall portion extending upward from the second bottom portion, and
the second wall portion is located along the first wall portion.

14. The breaker device according to claim 1, wherein
the conductor further includes a holding portion adjacent to the separating portion, and
after the pusher cuts off the separating portion, an upper end of the pusher is located at a level above a cut surface of the holding portion between the holding portion and the separating portion.

15. The breaker device according to claim 14, wherein
when the pusher presses the first projecting portion downward and stops, a distance between a lower end of the pusher and a lower end of the cut surface of the holding portion is greater than or equal to a distance between the upper end of the pusher and an upper end of the cut surface of the holding portion.

16. The breaker device according to claim 1, further comprising:
a resin member covering the conductor, wherein
the resin member includes:
an embedding portion in which the conductor is embedded;
a first cylindrical portion in which the pusher is disposed; and
a second cylindrical portion located at a level below the first cylindrical portion,
an inner diameter of the first cylindrical portion is less than an inner diameter of the second cylindrical portion, and
when the pusher presses the first projecting portion downward and stops, an upper end of the pusher is adjacent to the first cylindrical portion and a lower end of the pusher is adjacent to the second cylindrical portion.

17. A breaker device comprising:
a casing;
an igniter that generates gas;
a conductor including a separating portion located inside the casing;
a pusher that is located below the igniter and cuts off the separating portion from the conductor by receiving pressure of the gas generated by the igniter; and
a hollow member that is located inside the casing, is located below the separating portion, and is hollow inside, wherein
the separating portion is located below the pusher, and
when the pusher presses the hollow member, the hollow member deforms downward.
